(19) United States
(12) Patent Application Publication
(10) Pub. No.: US 2022/0318330 A1
(43) Pub. Date: Oct. 6, 2022

(54) Social Weather Map

(71) Applicant: Mackenzie Wellman, Zeelan, MI (US)

(72) Inventor: Mackenzie Wellman, Zeelan, MI (US)

(21) Appl. No.: 17/218,965

(22) Filed: Mar. 31, 2021

(51) Int. Cl. G06F 16/9537; G06F 16/9538

(52) U.S. Cl. CPC G06F 16/9537; G06F 16/9538

(57) ABSTRACT

A system and method for providing real time web user data, and more specifically, a system and method for providing a social weather map illustrating trending topics by time and location generated from Internet website data is disclosed. The method retrieves current topic data entries from a plurality of websites, the current topic data entries comprises a plurality of data entries added to one of the plurality of websites by an identifiable source, extracts current topic data from the current topic data entries, the current topic data comprises one or more topic terms, source location, and posting timestamp for each data entry, generates a count of references to each of the one or more topic terms for a given time period and location, stores the current topic data into a searchable database, generates a ranked list of current topic data by the corresponding count of references for the given time period, generates a social media weather map of a geographic area having a plurality of locations, each of the plurality of locations displays the count of references for one or more of the ranked list of current topic data generated within each location, and transmits the social media weather map to one or more of the client devices for display.

### TECHNICAL FIELD

This application relates in general to a system and method for providing real time web user data, and more specifically, to a system and method for providing a social weather map illustrating trending topics by time and location generated from Internet website data.

### BACKGROUND

A significant amount of human activity may be observed by reviewing the terms, topics, and expression of the topics from data posted onto various websites over time. By observing what topics are of most interest at a given time, a state of human activity, emotion, and thought may be determined. By analyzing how the frequency and location of these trending topics appears on these website as they change over time may provide useful information about how topics spread across a geographic area, on the frequency of a topic as it appears, grows, and dissipates, and about which geographic locations generate the most interest in a topic and when that peak interest occurs in the entire sequence of events. Visualizing and understanding this data requires processing and presentation of large amounts of data into useful formats.

Therefore, a need exists for a system and method for providing a social weather map illustrating trending topics by time and location generated from Internet website data. The present invention attempts to address the limitations and deficiencies in existing data analysis and presentation systems according to the principles and example embodiments disclosed herein.

### SUMMARY

In accordance with the present invention, the above and other problems are solved by providing a system and method for providing a social weather map illustrating trending topics by time and location generated from Internet website data according to the principles and example embodiments disclosed herein. The system provides a social weather map illustrating trending topics by time and location generated from an Internet website data by a social media web server to transmit a client device. The social media weather map web server communicatively connected to a plurality of web servers hosting publicly available websites and a plurality of client devices over the Internet, the web server includes a memory having instructions stored thereon and a processor configured to execute the instructions on the memory to cause the web server device to retrieve current topic data entries from a plurality of websites, the current topic data entries comprises a plurality of data entries added to one of the plurality of websites by an identifiable source, extract current topic data from the current topic data entries, the current topic data comprises one or more topic terms, source location, and posting timestamp for each data entry, generate a count of references to each of the one or more topic terms for a given time period and location, stores the current topic data into a searchable database, generate a ranked list of current topic data by the corresponding count of references for the given time period, generates a social media weather map of a geographic area having a plurality of locations, each of the plurality of locations displays the count of references for one or more of the ranked list of current topic data generated within each location, and transmit the social media weather map to one or more of the client devices for display.

In another aspect of the system and method, the processor is further configured to execute the instructions to cause the web server device to receive a social media weather map request from one of the plurality of client devices, the social media weather map specifies a time period, the area of the map to be displayed, and the size of each location within the social media weather map, generate a requested social media weather map from current topic data in the database corresponding to the specified time period and area of the map to be displayed, and transmit the requested social media weather map the client devices generating the request.

In another aspect of the system and method, the social media weather map request may reference a previously generated social media weather map having a related time period, area of the map, and the size of the locations, a subsequently generated social media weather map corresponds to a related social media weather map.

In another aspect of the system and method, the subsequently generated social media weather map presents a map location size and time period matching the previously generated social media weather map with the area of the map displayed contains additional locations adjacent to one or more locations within the previously generated social media weather map.

In another aspect of the system and method, the subsequently generated social media weather map presents a location and are of the map matching the previously generated social media weather map with the time period corresponding to an adjacent time period.

In another aspect of the system and method, the subsequently generated social media weather map presents a location and time period matching the previously generated social media weather map with the time period corresponding to a sequence of sequential time periods, each of the time periods within the sequence of sequential time periods presenting a separate social media weather map.

In another aspect of the system and method, the current topic data entries retrieved by a software bot transmitted by the social media weather map server to each of the plurality of websites.

In another aspect of the system and method, the plurality of websites have social media posting, likes, comments, and shared posts.

In another aspect of the system and method, each generated social media weather map server further comprises the ranked list of ranked list of current topic data for the corresponding time period.

In another aspect of the system and method, the generated social media weather map server is displayed by the client device using a web browser.

In another embodiment, the present invention is system and method for providing a social weather map illustrating trending topics by time and location generated from Internet website data. The method retrieves current topic data entries from a plurality of websites, the current topic data entries comprises a plurality of data entries added to one of the plurality of websites by an identifiable source, extracts current topic data from the current topic data entries, the current topic data comprises one or more topic terms, source location, and posting timestamp for each data entry, generates a count of references to each of the one or more topic terms for a given time period and location, stores the current topic data into a searchable database, generates a ranked list of current topic data by the corresponding count of references for the given time period, generates a social media weather map of a geographic area having a plurality of locations, each of the plurality of locations displays the count of references for one or more of the ranked list of current topic data generated within each location, and transmits the social media weather map to one or more of the client devices for display.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of a system and method for providing a social weather map illustrating trending topics by time and location generated from Internet website data according to the present invention.

FIG. 2 illustrates another example embodiment of a system and method for providing a social weather map illustrating trending topics by time and location generated from Internet website data according to the present invention.

FIG. 3 illustrates an example embodiment of a programmable processing system and its component processing modules for providing a social weather map illustrating trending topics by time and location generated from Internet website data according to the present invention.

FIG. 4 illustrates a method and algorithm for providing a social weather map illustrating trending topics by time and location generated from Internet website data according to the present invention.

FIG. 5 illustrates a method and algorithm for providing a social weather map illustrating search topics and trending topics by time and location generated from Internet website data according to the present invention.

FIG. 6 illustrates a generalized schematic of a programmable processing system utilized as the various computing components described herein used to implement an embodiment of the present invention.

### DETAILED DESCRIPTION

This application relates in general to a system and method for providing real time web user data, and more specifically, to a system and method for providing a social weather map illustrating trending topics by time and location generated from Internet website data.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “customer,” and “user” refer to an entity, e.g. a human, using the social weather map associated with the invention. The term user herein refers to one or more users.

The term “invention” or “present invention” refers to the invention being applied for via the patent application with the title “Social Weather Map.” Invention may be used interchangeably with weather map and map.

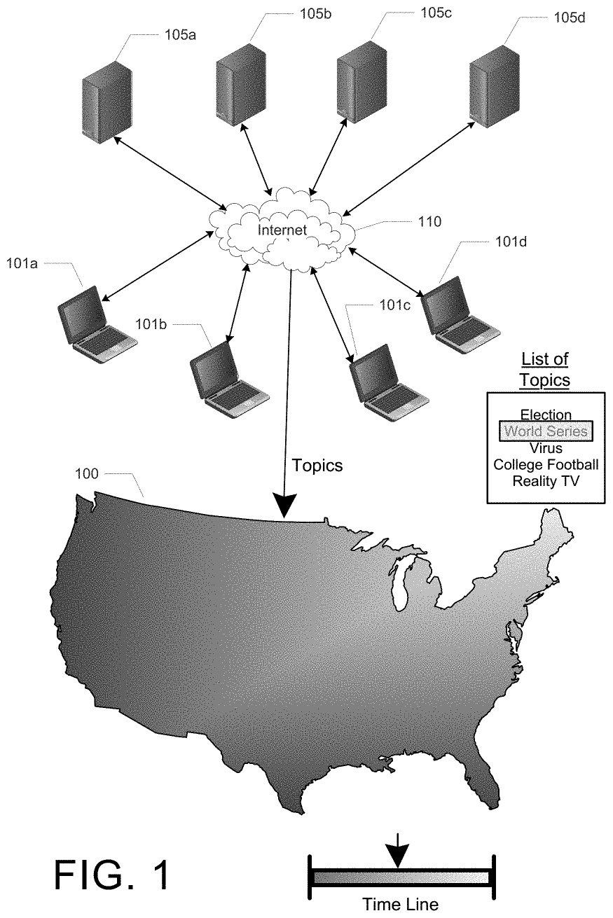

In general, the present disclosure relates to a system and method for providing real time web user data. To better understand the present invention, FIG. 1 illustrates an example embodiment of a system and method for providing a social weather map illustrating trending topics by time and location generated from Internet website data according to the present invention. A large number of users 101a-d are accessing, searching, chatting about, posting about, commenting on, and consuming data related to topics of interest from a vast number of websites 105a-d at any given time. This set of topics of interest changes over time as topics rise and fall in the interest of these users 101a-d. Obtaining and analyzing this data over time provides individuals and organizations an in depth analysis of the thoughts and interests of these users as events in the world occur.

A social weather map 100 is a visual representation of trending topic data collected and presented to users. A website collects information from online sources and then shows the info geographically based on the quantity of posts in a conversation. The goal of the site is to track human conversation topics and their pattern as they spread geographically. Contact conversation tracing over time may be determined using this data. A slide bar can show the growth and decline of internet conversation over a period of time. This social weather map 100 helps users to visualize the virtual conversation from start to finish both geographically and over a period of time.

Visualization would appear in a heat map format that would be over the geographic area where the population is talking about a topic. There would be a “word cloud analysis that shows the topics being talked about the most using a search for specific words. A “word cloud” is a visual representation of word frequency. The more commonly the term appears within the text being analyzed, the larger the word appears in the image generated. Word clouds are increasingly being employed as a simple tool to identify the focus of written material.

Sources of information are pulled from local news sites, country and national news sites, international news sites, social media/networking sites and related mobile applications, and search history data from search sites such as Google, Yahoo, Bing, Duck Duck Go and the like. The social weather map 100 facilitates tracking users in a visual manner: where people are talking about a topic, what are the major topics being talked about in a geographic location, the geographic spread of topics being talked about, and notifications of when a topic is being talked about in a geographic location exceeds set parameters.

All 3 “ranges” are wrong or backwards; and all can't end in 1 mill. For example, a population of 1,000,000-10,000 people is talking about a topic; 1% of the area talking about the same topic represents a light shower of conversation on X topic. For example, a population of 1,000,000-100,000 people is talking about a topic; 10% of the area talking about the same topic represents a heavy rain of conversation on X topic. For example, a population of 1,000,000-500,000 people is talking about a topic; 50% of the area talking about the same topic represents a major storm of conversation on X topic.

The social weather map 100 reflects the spread of a topic over other geographic areas to see the conversation moving from its original location. An origin of storm may be determined with a flag on the origin of a conversation. Data and statistics may be culled from the pattern of topics and conversations based on periodic extraction of information from online sources. The heat map also includes a “forecast” when a rate of action is increasing or dissipating for a particular topic then “forecast” may be indicated that anticipation exists for a possible communication storm in the near future. The social weather map 100 presents its data like a dew point map in many weather data sources. When the dew point gets higher, the chances of rain and eventually storms also increases. The social weather map 100 may “forecast” if the rate of action is increasing or dissipating then the system may “forecast” if there is going to be a communication storm.

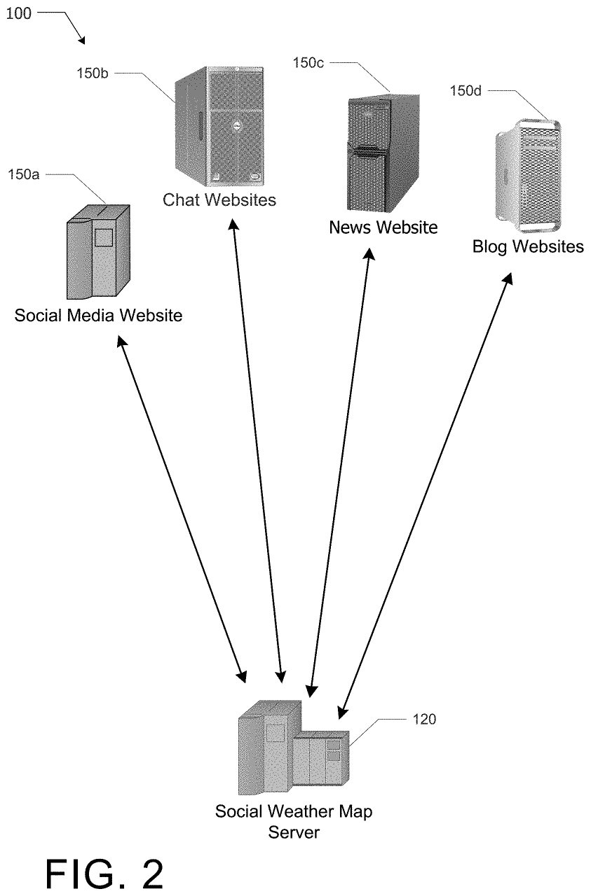

FIG. 2 illustrates another example embodiment of a system and method for providing a social weather map illustrating trending topics by time and location generated from Internet website data according to the present invention. In order to generate a social weather map 100, a social weather map server 120 contacts various data sources 150a-d on the Internet 110 to collect current data that has been added to searches during a time period. The various data sources 150a-d include social media websites 150a, chat websites 150b, news websites 150c, blog websites 150d, and other similar websites.

The social weather map server 120 retrieves the website data, extracts topics from the data, counts instances of the topics by time stamp and location, generates a trending topic list for a certain time interval, and organizes the counted data by time and location into a database. The social weather map server 120 may then retrieve the data from the database for a sequence of time intervals and plot a weather map 100 illustrating the frequency of a particular topic by location on the map. By stepping through a sequence of time intervals, a user may observer where a topic first became a trending topic, observe how it spread or migrated over time by geographic location, how intense the topic became at various points in time and location, and how the intensity of the topic dropped off as interest in the topic waned. A user may retrieve and review these social weather maps 100 to analyze any topic or topics of interest.

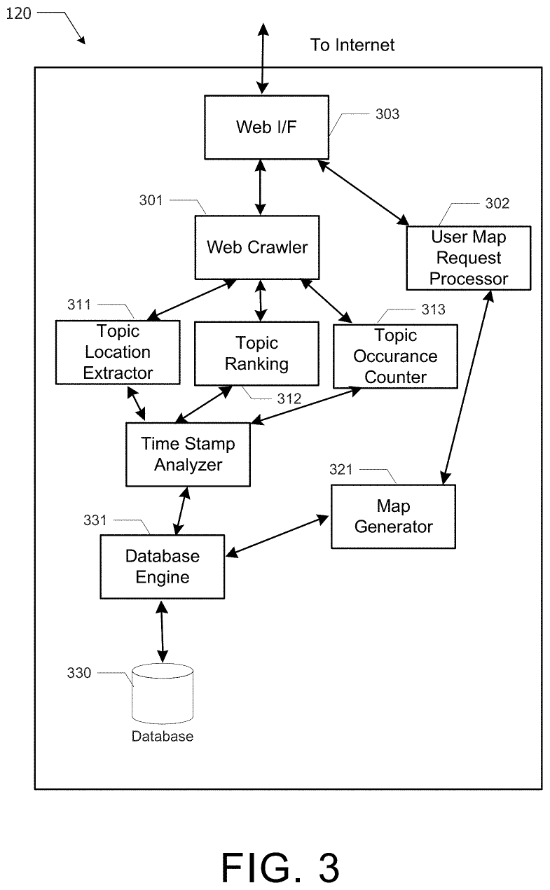

FIG. 3 illustrates an example embodiment of a programmable processing system and its component processing modules within a social weather map server 120 for providing a social weather map illustrating trending topics by time and location generated from Internet website data according to the present invention. The social weather map server 120 is constructed using a set of processing components that include a web crawler 301, a user map request processor 302, a web interface 303, a topic location extractor 311, a topic ranking processor 312, a topic occurrence counter 313, a time stamp analyzer 314, a map generator 321, a database engine 331, and a database 330.

The web crawler 301 sends out data requests to websites 105a-n on the Internet 110 to obtain data associated with the material appearing on the web site. The web crawler 301 consumes the data and searches for trending terms that are appearing in a large number of web sites. All of the data and trending terms are provided to the various components in the social weather map server 120 to generate the trending term, location, and time stamp data needed to be stored within the database 330 so that it may be used to generate social weather map datasets upon requests from a user.

Additional details of the process of consuming content from various websites and then processed: Social Media, chat websites, news website, blog posts, for example, post about a topic, news article, hashtag, and content. Then the amount of like's, comments, or reactions the post receives may be used to count towards the topic. The registered location of the poster and the reactor is used to determine a location on the social weather map is to be the counted. This process may require agreement with social media platforms to give the location of the user.

The user map request processor 302 receives social weather map requests from users over the Internet 110 and submits the request to the social weather map generator 321. The user map request processor 302 parses the user request to obtain the geographic location of interest, the trending term of interest, the time period of interest and the spatial and time interval resolution to be utilized in generating the social weather map dataset of maps. The user map request processor 302 receives the social weather map dataset of maps from the social weather map generator 321 and returns the dataset to the requesting user via the web interface 303.

The web interface 303 permits the social weather map server 120 to communicate with remote user computing devices 101a-d and data source websites 105a-d as needed. The web interface performs all of the data formatting, computer to computer communications, encryption processing, and all similar operations needed by the web server to communicate with users.

The topic location extractor 311 determines location data being for a given like, comment and response. The topic location extractor 311 obtains the location area start to spread if there are a lot of reactions. The topic location extractor 311 should also be able to see the location area dissipate as the amount of reactions expire.

The topic location extractor 311 also determines locations of the likes, comments, and reactions as news article may be counted for the zip codes a particular news outlet represents. Local news may be counted towards the area in which it broadcasts. If someone shares a particular article, the share counts for the area that particular user is registered. Any reactions to a post may be counted towards the reactor's registered location. National news will have a count in each zip code one time once posted.

The topic ranking processor 312 maintains a ranked list of topics generated by the topic occurrence counter 313 for a time period and location as provided by the topic location extractor 311 and the time stamp analyzer 314.

The topic occurrence counter 313 works with the topic location extractor 311 and the time stamp analyzer 314 to determine counts generated for posts, likes, comments, shares and reactions by time period and location as determined by the other modules.

The time stamp analyzer 314 determines time data being for a given like, comment and response. The time of the like, comment and response may be obtained from the items themselves. All post, comments, reactions typically have a 24-hour time stamp. The topic location extractor 311 obtains the location area start to spread if there are a lot of reactions. The topic location extractor 311 should also be able to see the location area dissipate as the amount of reactions expire. The time stamp analyzer 311 also may determine a forecast based on a changing rate of reactions. For example, as the conversation spreads on social platforms, the time stamp analyzer 311 can calculate the increase of reactions per minute or hour. The time stamp analyzer 311 can also calculate the amount of reactions expiring per min or hour to show a conversation clearing up. The time period for a typical time period may include a 24 hour expiration of a post, comment share, like, and response.

The social weather map generator 321 retrieves trending topic data including its term or terms of expression, its time stamp and location of occurrences, and the frequency of the occurrences over a sequence of time intervals for use in visually presenting the data to users. For each time interval in the sequence of time intervals, the frequency of the occurrence of a trending term is plotted by location on the map. A map is made for each time interval and all of the maps are included in a dataset that is provided to a user in response to a user request. The social weather map generator 321 permits users to specify the length of the sequence of time intervals requested for a particular dataset, to specify the time between each time interval to be reported in the data set, and select the spatial resolution of the map into which the occurrence data is to be spatially presented. The social weather map generator 321 combines all of the time interval samples in the time period requested by a user to obtain a proper average value for each geographic location in the map. Users may zoom into and out of a map to view the occurrence data for a particular region of the map at a desired spatial resolution. A past history of the generated social weather maps may be retained and provided to users as requested.

The database engine 331 processes all database operations for the social weather map data. These operations include insertion of topic time and location data into the database 330, deletion of topic time and location data from the database 330, searching and retrieving topic time and location data from the database 330 for use in creating the social weather map 100, and indexing the database 330 to maintain efficient searching when needed.

The database 330 is a data set of social weather map trending topics, time stamps, and locations data that is organized in an efficient manner for access by the database 331. The database 330 is maintained on a storage device for long term storage and retrieval by users via the database engine 331.

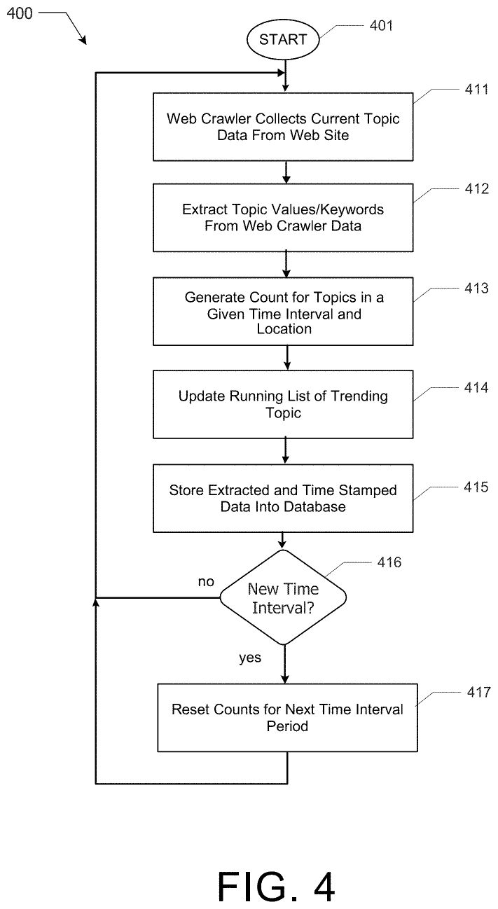

FIG. 4 illustrates a method and algorithm for providing a social weather map illustrating trending topics by time and location generated from Internet website data according to the present invention. The process 400 begins 401 and the web crawler 301 collects data from source websites in step 411. In step 412, trending topics are identified and extracted from the web crawler data for use in generating social weather map 100 data.

With the web crawler data, the social weather map server 120 generates a count of the occurrences for a trending topic in the web crawler data by both geographic location and time stamp in step 413. A running list of trending topics is generated and maintained in step 414 from the counts of occurrences of terms previously extracted and identified from the web crawler data. The trending term data and its count by location and time stamp is stored into the database 330 in step 415.

Test step 416 determines whether or not the web crawler data for a time interval has been completed and a new time interval processing is to begin, and if not, the process 400 returns to step 412 to continue processing the web crawler data for the given time interval. When test step 416 determines that processing of a new time interval is to begin, the counters for trending topics and their corresponding counts by location and time stamp are all reset to zero to count the occurrences in the next time interval before the process returns to step 412 to process the web crawler data obtained in the next time interval. This processing continues as along as the social weather map server 120 is collecting data to generate social weather maps 100 and provide them to users.

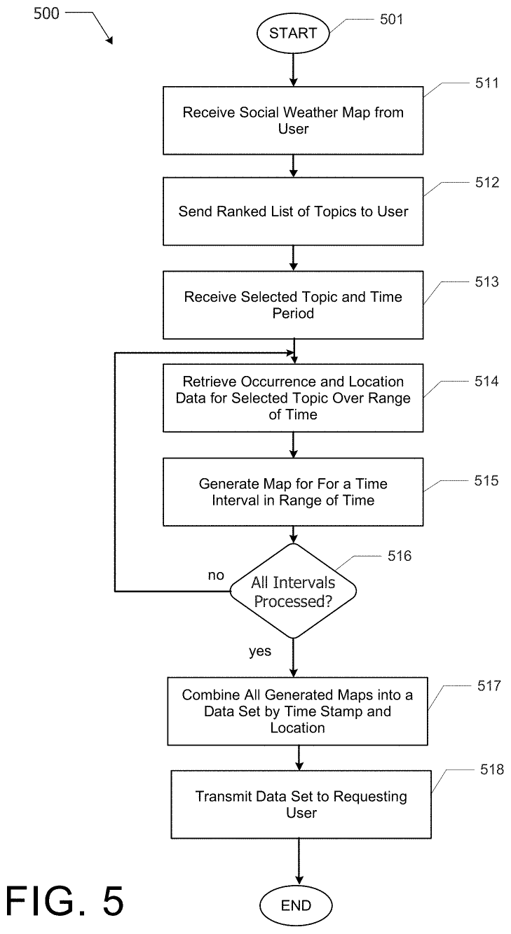

FIG. 5 illustrates a method and algorithm for providing a social weather map illustrating search topics and trending topics by time and location generated from Internet website data according to the present invention. The process 500 performs the operations within the social weather map server 120 to generate a social weather map 100 dataset in response to a user request received over the Internet 110. The process 500 begins 501 and the social weather map server 120 receives a user request in step 511. The social weather map server 120 sends a list of available trending topics available for presentation as a social weather map 100 in step 512. In step 513 the social weather map server 120 receives a request for a social weather map 100 dataset for a particular term that specifies a geographic area and a time period of interest to be covered by the social weather map 100 dataset.

The social weather map server 120 in step 514 retrieves occurrence location and topic data corresponding to a time interval from the database 330 over a specified location and time period. In step 515 a social weather map 100 is generated for the selected time interval within the time range of interest. Test step 516 determines whether or not all of the social weather maps 100 for inclusion within the dataset to be sent to the requesting user have been generated, and if not, the process 500 returns to step 514 to generate the next time interval social weather map 100. When all of the time intervals for the dataset being generate for a user have been generated, the process 500 proceeds to step 517 in which all of the generated social weather map data is combined into a single dataset having a requested spatial and time interval resolution. The dataset is sent to the requesting user in step 518 and the process 500 ends.

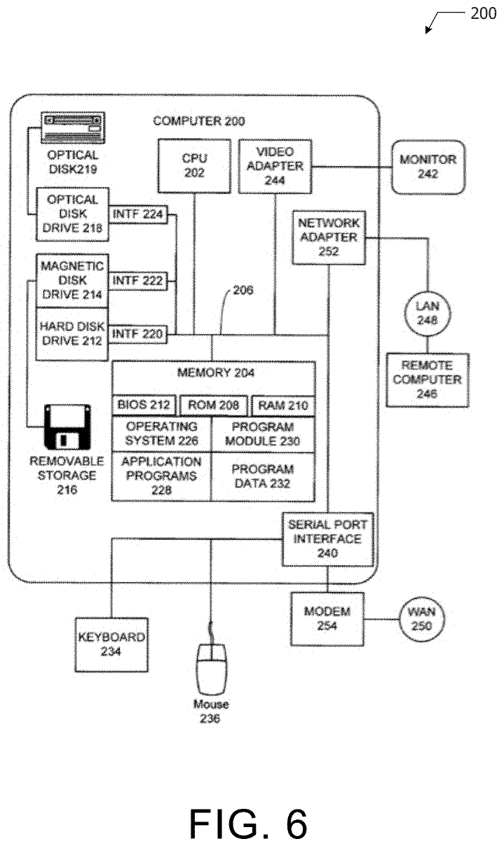

FIG. 6 illustrates a generalized schematic of a programmable processing system utilized as the various computing components described herein used to implement an embodiment of the present invention. The social weather map server 120 may be implemented as a digital processing system 200 that contains software in the form of executable instructions stored within memory of the system controller 112. When the CPU 202 executes these instructions in memory, the system controller 112 performs the functions of the system 100 as described herein.

The CPU 202 is coupled to the system bus 204. The CPU 202 may be a general-purpose CPU or microprocessor, graphics processing unit (“GPU”), and/or microcontroller. The present embodiments are not restricted by the architecture of the CPU 202 so long as the CPU 202, whether directly or indirectly, supports the operations as described herein. The CPU 202 may execute the various logical instructions according to the present embodiments.

The computer system 200 also may include random access memory (RAM) 208, which may be synchronous RAM (SRAM), dynamic RAM (DRAM), synchronous dynamic RAM (SDRAM), or the like. The computer system 200 may utilize RAM 208 to store the various data structures used by a software application. The computer system 200 also may include read only memory (ROM) 206 which may be PROM, EPROM, EEPROM, optical storage, or the like. The ROM may store configuration information for booting the computer system 200. The RAM 208 and the ROM 206 hold user and system data, and both the RAM 208 and the ROM 206 may be randomly accessed.

The computer system 200 also may include an input/output (I/O) adapter 210, a communications adapter 214, a user interface adapter 216, and a display adapter 222. The I/O adapter 210 and/or the user interface adapter 216 may, in certain embodiments, enable a user to interact with the computer system 200. In a further embodiment, the display adapter 222 may display a graphical user interface (GUI) associated with a software or web-based application on a display device 224, such as a monitor or touch screen.

The I/O adapter 210 may couple one or more storage devices 212, such as one or more of a hard drive, a solid-state storage device, a flash drive, a compact disc (CD) drive, a floppy disk drive, and a tape drive to the computer system 200. According to one embodiment, the data storage 212 may be a separate server coupled to the computer system 200 through a network connection to the I/O adapter 210. The communications adapter 214 may be adapted to couple the computer system 200 to the network 208, which may be one or more of a LAN, WAN, and/or the Internet. The communications adapter 214 also may be adapted to couple the computer system 200 to other networks such as a global positioning system (GPS) or a Bluetooth network. The user interface adapter 216 couples user input devices, such as a keyboard 220, a pointing device 218, and/or a touch screen (not shown) to the computer system 200. The keyboard 220 may be an on-screen keyboard displayed on a touch panel. Additional devices (not shown) such as a camera, microphone, video camera, accelerometer, compass, and or gyroscope may be coupled to the user interface adapter 216. The display adapter 222 may be driven by the CPU 202 to control the display on the display device 224. Any of the devices 202-222 may be physical and/or logical.

The applications of the present disclosure are not limited to the architecture of the computer system 200. Rather the computer system 200 is provided as an example of one type of computing device that may be adapted to perform the functions of a social weather map, including servers, personal computers, and mobile devices as shown in FIG. 3. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 200 may be virtualized for access by multiple users and/or applications.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A system for providing a social weather map illustrating trending topics by time and location generated from an Internet website data by a social media web server to transmit a client device, the social media weather map web server communicatively connected to a plurality of web servers hosting publicly available websites and a plurality of client devices over the Internet, the web server comprises:
a memory having instructions stored thereon; and
a processor configured to execute the instructions on the memory to cause the web server device to:
retrieve current topic data entries from a plurality of websites, the current topic data entries comprises a plurality of data entries added to one of the plurality of websites by an identifiable source;
extract current topic data from the current topic data entries, the current topic data comprises one or more topic terms, source location, and posting timestamp for each data entry;
generate a count of references to each of the one or more topic terms for a given time period and location;
store the current topic data into a searchable database;
generate a ranked list of current topic data by the corresponding count of references for the given time period;
generate a social media weather map of a geographic area having a plurality of locations, each of the plurality of locations displays the count of references for one or more of the ranked list of current topic data generated within each location; and
transmit the social media weather map to one or more of the client devices for display.

2. The system according to claim 1, wherein the processor further configured to execute the instructions to cause the web server device to:
receive a social media weather map request from one of the plurality of client devices, the social media weather map specifies a time period, the area of the map to be displayed, and the size of each location within the social media weather map;
generate a requested social media weather map from current topic data in the database corresponding to the specified time period and area of the map to be displayed; and
transmit the requested social media weather map the client devices generating the request.

3. The system according to claim 2, wherein the social media weather map request may reference a previously generated social media weather map having a related time period, area of the map, and the size of the locations, a subsequently generated social media weather map corresponds to a related social media weather map.

4. The system according to claim 3, wherein the subsequently generated social media weather map presents a map location size and time period matching the previously generated social media weather map with the area of the map displayed contains additional locations adjacent to one or more locations within the previously generated social media weather map.

5. The system according to claim 3, wherein the subsequently generated social media weather map presents a location and are of the map matching the previously generated social media weather map with the time period corresponding to an adjacent time period.

6. The system according to claim 5, wherein the subsequently generated social media weather map presents a location and time period matching the previously generated social media weather map with the time period corresponding to a sequence of sequential time periods, each of the time periods within the sequence of sequential time periods presenting a separate social media weather map.

7. The system according to claim 1, wherein the current topic data entries retrieved by a software bot transmitted by the social media weather map server to each of the plurality of websites.

8. The system according to claim 1, wherein the plurality of websites have social media posting, likes, comments, and shared posts.

9. The system according to claim 1, wherein each generated social media weather map server further comprises the ranked list of ranked list of current topic data for the corresponding time period.

10. The system according to claim 9, wherein the generated social media weather map server is displayed by the client device using a web browser.

11. A method for providing a social weather map illustrating trending topics by time and location generated from Internet website data by a social media weather map web server to transmit to a client device, the social media weather map web server communicatively connected to a plurality of web servers hosting publicly available websites and a plurality of client devices over the Internet, the method comprising:
retrieving current topic data entries from a plurality of websites, the current topic data entries comprises a plurality of data entries added to one of the plurality of websites by an identifiable source;
extracting current topic data from the current topic data entries, the current topic data comprises one or more topic terms, source location, and posting timestamp for each data entry;
generating a count of references to each of the one or more topic terms for a given time period and location;
storing the current topic data into a searchable database;
generating a ranked list of current topic data by the corresponding count of references for the given time period;
generating a social media weather map of a geographic area having a plurality of locations, each of the plurality of locations displays the count of references for one or more of the ranked list of current topic data generated within each location; and
transmitting the social media weather map to one or more of the client devices for display.

12. The method according to claim 11, wherein the method further comprising:
receiving a social media weather map request from one of the plurality of client devices, the social media weather map specifies a time period, the area of the map to be displayed, and the size of each location within the social media weather map;
generating a requested social media weather map from current topic data in the database corresponding to the specified time period and area of the map to be displayed; and
transmitting the requested social media weather map the client devices generating the request.

13. The method according to claim 12, wherein the social media weather map request may reference a previously generated social media weather map having a related time period, area of the map, and the size of the locations, a subsequently generated social media weather map corresponds to a related social media weather map.

14. The method according to claim 13, wherein the subsequently generated social media weather map presents a map location size and time period matching the previously generated social media weather map with the area of the map displayed contains additional locations adjacent to one or more locations within the previously generated social media weather map.

15. The method according to claim 13, wherein the subsequently generated social media weather map presents a location and are of the map matching the previously generated social media weather map with the time period corresponding to an adjacent time period.

16. The method according to claim 15, wherein the subsequently generated social media weather map presents a location and time period matching the previously generated social media weather map with the time period corresponding to a sequence of sequential time periods, each of the time periods within the sequence of sequential time periods presenting a separate social media weather map.

17. The method according to claim 11, wherein the current topic data entries retrieved by a software bot transmitted by the social media weather map server to each of the plurality of websites.

18. The method according to claim 11, wherein the plurality of websites have social media posting, likes, comments, and shared posts.

19. The method according to claim 11, wherein each generated social media weather map server further comprises the ranked list of ranked list of current topic data for the corresponding time period.

20. The method according to claim 19, wherein the generated social media weather map server is displayed by the client device using a web browser.
